(19) United States
(12) Patent Application Publication
(10) Pub. No.: US 2015/0040629 A1
(43) Pub. Date: Feb. 12, 2015

(54) Novel Mycorrhizae-based Biofertilizer Compositions & Method for mass production & formulations of Same

(71) Applicant: Adholeya Alok, New Delhi (IN)

(72) Inventor: Adholeya Alok, New Delhi (IN)

(73) Assignee: THE ENERGY AND RESOURCES INSTITUTE (TERI), New Delhi (IN)

(21) Appl. No.: 14/369,510

(22) PCT Filed: Dec. 30, 2011
(86) PCT No.: PCT/IN2011/000907

§ 371 Date: Oct. 5, 2014

(51) Int. Cl. C05F 11/08; C05F 17/00

(52) U.S. Cl. CPC C05F 11/08; C05F 17/00
USPC 71/23

(57) ABSTRACT

This invention relates generally to the field of compositions and methods for developing biofertilizers of organic origin and mycorrhizal origin in particular. The invention focuses on the isolation and characterization of the various formulations and ensuing compositions developed thereof from the arbuscular mycorrhizal fungal propagules whose benefit in crop productivity is well known. The invention more particularly describes the isolation and characterization, including but not confined to, novel mycorrhizae-based biofertilizer compositions and biofertilizer formulations for use in soil fertilization and reclamation of industrially created wastelands.

### FIELD OF INVENTION

This invention relates generally to the field of compositions and methods for developing biofertilizers of organic origin and mycorrhizal origin in particular. The invention focuses on the isolation and characterization of the various formulations and ensuing compositions developed thereof from the arbuscular mycorrhizal fungal propagules whose benefit in crop productivity is well known. The invention more particularly describes the isolation and characterization, including but not confined to, novel mycorrhizae-based biofertilizer compositions and biofertilizer formulations for use in soil fertilization and reclamation of industrially created wastelands.

### BACKGROUND OF INVENTION

The last few decades have witnessed in general a large amount of activity in the general field of fertilizers and the biofertilizers in particular have attracted special attention, primarily on account of them having been derived from natural sources and having an essentially biological origin and their possible exploitation in the numerous fields. The prior art is flooded with a large number of patented inventions and technical literature on the subject in question.

It is common knowledge that, agriculture is the science, art, and business of cultivating the soil, producing crops, raising livestock; and farming. With respect to cultivating the soil and producing crops, it is well known to add various fertilizing and other compositions to the soil and/or plant foliage in order to improve results. The agents that have been added to soil and/or plant tissues include microbial agents, which impart some beneficial property to the soil and/or plant to provide for desirable results.

Over the last few decades of modern scientific advancement, the emerging knowledge bank has revealed that, that plants may be serving as a reservoir of untold numbers of organisms known as endophytes (Bacon, C. W., and White, J. F. 2000. Microbial Endophytes. Marcel Deker Inc., N.Y.). By definition, these microorganisms (mostly fungi and bacteria) live in the intercellular spaces of plant tissues. Some of these endophytes may be producing bioactive substances that, in some way, may be involved in the host endophyte relationship. As a direct result of the role that these secondary metabolites may play in nature, they may ultimately be shown to have applicability in medicine, agriculture and industry. We are now witnessing the beginning a worldwide scientific effort to isolate endophytes and study their natural products. While there are myriads of epiphytic microorganisms associated with plants, the endophytic ones seem to be attracting more attention. This may be the case since closer biological associations may have developed between these organisms in their respective hosts than the epiphytes. Hence, the result of this may be the production of a greater number and diversity of classes of biological derived molecules possessing a range of biological activities. In fact, a recent comprehensive study has indicated that 51% of biologically active substances isolated from endophytic fungi were previously unknown (Schutz, B. 2001. British Mycological Society, International Symposium Proceedings, Bioactive Fungal Metabolites—Impact and Exploitation. University of Wales, April.). This compares with only 38% novel substances from soil microflora.

The studies in this area have shed light on the factual premise that amongst the least studied biochemical-chemical systems that are prevelant in nature, it is the relationship existing between microorganisms and their plant hosts which assumes special significance. It may be noted for instance, it does appear that all higher plants are hosts to one or more endophytic microbes. These microbes may include the fungi, bacteria and actinomycetes and reside in the tissues beneath the epidermal cell layers. It is also well understood that endophytic infections are at least inconspicuous. And as a result, the host tissues are transiently symptomless and the colonization of the tissues is internal to the surface of the plant. The exact physical relationship of the endophyte to the plant has, in most cases, remained obscure because it is extremely difficult, by electron microscopic techniques, to find an endophyte within plant tissues. Conceivably, the microbes live within the intercellular spaces of the tissues and it also seems likely that penetration of living cells may occur but is not easy to observe.

A study of the fossil records has indicated that fungi have been associated with plants since at least 400 million years ago (Simon, et al., Origin and diversification of endomycorrhizal fungi and coincidence with vascular land plants, Nature 363, 67 69 (1993); Remy, et al., Four hundred-million-year-old vesicular arbuscular mycorrhizae, Proc. Nat. Acad. Sci. 91, 11841 11843 (1994); Redecker, et al., Fungi from the Ordovician, Science 289, 1920 1921 (2000), all of which are expressly incorporated by reference) and it is an astute theoretical assumption that early symbiotic interactions were possibly responsible for playing a key role in the establishment of land plants (Pirozynski, et al., The origin of land plants: a matter of mycotrophism, Biosystems 6, 153 164 (1975), expressly incorporated by reference). Since the first description of plant/fungal symbiosis (De Bary, A., Die Erschenung Symbiose, in Vortrag auf der Versammlung der Naturforscher and Adze zu Cassel (ed. Trubner, K. J.) 1 30 (Strassburg, 1879); Hertig, M., et al., The terms symbiosis, symbiont and symbiote, J. Parasit. 23, 326 329 (1937) all of which are expressly incorporated by reference), all plants studied in natural ecosystems have been found to be symbiotic with fungi (Petrini, O., Taxonomy of endophytic fungi of aerial plant tissues, in Microbiology of the Phyllosphere (eds. Fokkema, N.J. & van den Heuvel, J.) 175 187 (Cambridge University Press, Cambridge, 1986) expressly incorporated by reference). These fungi, termed endophytes, express a variety of symbiotic lifestyles including mutualism, commensalism, or parasitism that positively, neutrally, or negatively affect host fitness, respectively (Lewis, D. H., Symbiosis and mutualism: crisp concepts and soggy semantics, in The Biology of Mutualism (ed. Boucher, D. H.) 29 39, (Croom Helm Ltd, London, 1985), expressly incorporated by reference).

The host range, here defined as the ability to colonize a plant, of most symbiotic fungi is poorly defined. With the exception of vesicular arbuscular mycorrhizae, there are few reports of fungal symbionts asymptomatically colonizing both monocots and eudicots (Smith, A. F. & Smith, S. E., Structural diversity in (vesicular)-arbuscular mycorrhizal symbioses, New Phytol. 137, 373 388 (1997); Jumpponen, A. & Trappe, J. M., Dark septate endophytes: a review of facultative biotrophic root-colonizing fungi, New Phytol. 140, 295 310 (1998); Bordallo, J. J. et al., Colonization of plant roots by egg-parasitic and nematode-trapping fungi, New Phytol. 154, 491 499 (2002) all of which are expressly incorporated by reference). This may indicate host range limitations or a limited number of plant taxa analyzed during host range studies. Moreover, individual fungi can express different lifestyles in different plant hosts and, although the basis of symbiotic communication responsible for the outcome of these associations (mutualistic, commensal, or parasitic) is unknown, lifestyle expression appears to be controlled by the plant genome (Smith, K. P. & Goodman, R. M., Host variation for interactions with beneficial plant-associated microbes, Annu. Rev. Phytopathol. 37, 473 492 (1999); Redman, et al., Fungal symbiosis: from mutualism to parasitism, who controls the outcome, host or invader? New Phytol. 151, 705 716 (2001) all of which are expressly incorporated by reference).

Adaptation of plants to selective pressures is also considered to be regulated by the plant genome (Smallwood, M. F., Calvert, C. M. & Bowles, D. J. Plant Responses to Environmental Stress (BIOS Scientific Publishers Limited, Oxford, 1999) expressly incorporated by reference). However, recent studies indicate that fitness benefits conferred by mutualistic fungi contribute to plant adaptation (Clay, K. & Holah, J., Fungal endophyte symbiosis and plant diversity in successional fields, Science 285, 1742 1744 (1999); Morton, J. B., Biodiversity and evolution in mycorrhizae in the desert, in Microbial Endophytes (eds. Bacon, C. W. & White, J. F. J.) 3 30 (Marcel Dekker, Inc., New York, N.Y., 2000); Redman, et al., Thermotolerance conferred to plant host and fungal endophyte during mutualistic symbiosis. Science In Press (2003) all of which are expressly incorporated by reference). Mutualistic fungi may confer tolerance to drought (Bacon, C. W., Abiotic stress tolerances (moisture, nutrients) and photosynthesis in endophyte-infected tall fescue, Agricult. Ecosys. Environ. 44, 123 141 (1993); Read, D. J., Mycorrhiza—the state of the art, in Mycorrhiza (eds. Varma, A. & Hock, B.) 3 34 (Springer-Verlag, Berlin, 1999) all of which are expressly incorporated by reference), metals (Read, D. J., Mycorrhiza—the state of the art, in Mycorrhiza (eds. Varma, A. & Hock, B.) 3 34 (Springer-Verlag, Berlin, 1999) all of which are expressly incorporated by reference), disease (Carroll, G. C., The biology of endophytism in plants with particular reference to woody perennials, in Microbiology of the Phyllosphere (eds. Fokkema, N. J. & Van Den Heuvel, J.) 205 222 (Cambridge University Press, Cambridge, 1986); Freeman, S. & Rodriguez, R. J., Genetic conversion of a fungal plant pathogen to a nonpathogenic, endophytic mutualist. Science 260, 75 78 (1993); Redman, et al. Biochemical analysis of plant protection afforded by a nonpathogenic endophytic mutant of Colletotrichum magna. Plant Physiol. 119, 795 804 (1999) all of which are expressly incorporated by reference), and herbivory (Latch, G. C. M. Physiological interactions of endophytic fungi and their hosts, Biotic stress tolerance imparted to grasses by endophytes, Agricult. Ecosys. Environ. 44, 143 156 (1993) expressly incorporated by reference), and/or promote growth (Marks, S. & Clay, K., Effects of CO2 enrichment, nutrient addition, and fungal endophyte-infection on the growth of two grasses, Oecologia 84, 207 214 (1990); Varma, A. et al., Pirifmospora indica, a cultivable plant-growth-promoting root endophyte, App. Environ. Microbiol. 65, 2741 2744 (1999); Redman, R. S. et al., Field performance of cucurbit and tomato plants colonized with a nonpathogenic mutant of Colletotrichum magna (teleomorph: Glomerella magna; Jenkins and Winstead), Symbiosis 32, 55 70 (2002) all of which are expressly incorporated by reference) and nutrient acquisition (Read, D. J., Mycorrhiza—the state of the art, in Mycorrhiza (eds. Varma, A. & Hock, B.) 3 34 (Springer-Verlag, Berlin, 1999) expressly incorporated by reference).

It is a well known fact today that, the arbuscular mycorrhizal fungi (AM) are beneficial fungi in the sense that they colonize the cells of feeding roots of plants and stimulate uptake of phosphorus from the soil. The hyphae of the fungus grow outwardly from the root, well beyond the phosphate depletion zone (the zone from which the available phosphate has already been consumed by the plant). Selected AM fungi have been shown to enhance the growth of numerous plants of economic importance (Bethlenfalvay, G. J., 1992, Amer. Soc. of Agr., Special Publication #54, Madison Wis., pp. 1-27), including agronomic, horticultural and forest plant.

Furthermore, it has been observed that colonization by an endomycorrhizal fungus may protect the roots of the mycorrhized plant from pathogens in the soil (Linderman, R. G., 1992, Amer. Soc. of Agr., Special Publication #54, Madison Wis. pp. 45-70).

However, despite the large amount of work carried out to date, the main difficulty in applying endomycorrhizae is that, it is not known how to produce their propagules in large quantities for commercial application (Wood, T. and B. Cummins, 1992, Mycorrhizae Functioning; an Integrative Plant-Fungal Process, pp. 468-487, Ed. M. F. Allen, Academic Press, New York). It is believed that no one has ever succeeded in cultivating them in a sterile medium without the host plant (Becard, G. & Y. Piche, 1992, Methods in Microbiology, Vol. 24, 90-108, Ed. Norris, Read & Varma, Academic Press, London).

Unlike most symbiotic micro-organisms which are parasitic or saprophytic, AM fungi are obligate biotrophs which have so far resisted all attempts to be cultivated axenically (in pure culture); (Williams, G., 1992, Methods in Microbiology, Vol. 24, 203-220. Ed. Norris, Read & Varma, Academic Press, London). This lack of independent growth has not prevented vesicular-arbuscular mycorrhizal fungi from becoming distributed world-wide as a symbiotic partner of most vascular plants, under a wide variety of pedologic and climatic conditions (Bethlenfalvay, G. J., 1992, Amer. Soc. of Agr., Special Publication #54, Madison Wis., pp. 1-29).

The large number of attempts at mycorrhization which have been carried out so far have consisted of using inoculums prepared from complete plants which are cultivated in pots or a greenhouse. Inoculation is nearly always carried out with specially gathered mycorrhizal roots, or sometimes with a suspension of spores, Jackson et al. (Jackson et al, 1972, Soil Sci. Soc. Amer. Proc., Vol. 36, 64-67) used lyophilized roots, while Hall (Hall I. R., 1979, Soil Biol. Biochem., Vol. 11, 85-86), recommends using soil pellets mixed with infected roots.

The studies have also indicated that VA (vesicular-arbuscular) mycorrhizal fungi are beneficial fungi in the sense that they infect the feeding roots of plants and stimulate uptake of phosphorus from the soil. The hyphae of the fungus grow outwardly from the root well beyond the phosphate depletion zone (the zone from which the available phosphate has already been consumed by the plant). Selected VA-mycorrhizal fungi have been shown to enhance the growth of numerous plants of economic importance, including vegetables [Haas et al, Agron. J., Vol. 79, “Vesicular-arbuscular Mycorrhizal Fungus Infestation and Phosphorus Fertigation to Overcome Pepper Stunting After Methyl Bromide Fumigation,” pages 905-910 (1987); Mohandas, Plant and Soil, Vol. 98, “Field Responses to Tomato (Lycopersicon esculentum) to Inoculation With a VA-mycorrhizal Fungus Glomus fasciculatum and Azotobacter virelandii, pages 295-297 (1987); Plenchette et al, Plant and Soil, Vol. 70, “Growth Response of Several Plant Species to Mycorrhizae in a Soil of Moderate Phosphorus Fertility I. Mycorrhizal Dependency Under Field Conditions,” pages 197-209 (1983)]; field crops [Baltruschat, Zeitschrift fur Pflanzenkrankheiten and Pflanzenschutz, Vol. 94, “Field Inoculation of Maize with Vesicular-arbuscular Mycorrhizal Fungi by Using Expanded Clay as Carrier Material for Mycorrhiza,” pages 419-430 (1987); Hall, J. Agr. Sci., Vol. 102, “Field Trials Assessing the Effect in Inoculating Agricultural Soils With Endomycorrhizal Fungi,” pages 725-731 (1984); Medina et al, Biol. Fert. Soils, “Growth Response of Field-grown Siratro (Macroptilium atropurpureum Urb.) and Aeschynomene americana L. to Inoculation With Selected Vesicular-arbuscular Mycorrhizal Fungi,” Vol. 9, pages 54-60 (1990)] and native plants used for revegetation [Dehgan et al, Bartow, Fla.: Florida Institute of Phosphate Research, “Propagation and Mycorrhizal Inoculation of Indigenous Florida Plants for Phosphate Mine Revegetation, No. 03-053-076, 225 pages (1989); Sylvia, J. Coastal Res., Vol. 5, “Nursery Inoculation of Sea Oats with Vesicular-arbuscular Mycorrhizal Fungi and Outplanting Performace of Florida Beaches,” pages 747-754 (1989)]. Nonetheless, VA-mycorrhizal fungi are not used widely in crop production, partially because inoculum sources are limited and application technologies are not well developed.

The recent advancements in the field of scientific and technical research have shown that, most of the plant species possess the capability to exploit the soil with the help of beneficial microorganisms called Mycorrhizal fungi. The fine threads that make up the fungus branch between soil particles, grow into decomposing organic matter, even explore the shells of dead insects, where they find phosphorus and other vital nutrients. The nutrients are then passed back to the roots of the plant. Mycorrhizae has a vast potential as biofertilizer for augmenting nutritional capabilities of the plant roots. Mycorrhizae has benefited both the plants and the soil/fly ash/substrate. Plant benefits include augmentation of the supply of phosphorus and trace elements (iron, boron, zinc, copper etc.) protection of plant roots from root diseases, high soil temperatures, and high salt concentrations, amongst others. They carry a specific property of arresting heavy metals and significantly reduce the movement of heavy metals into soil and ground water, thus reducing their contamination. These microorganisms are also responsible for aggregation of substrate particles along with helping plants to develop profuse root biomass, which further enhances particle aggregation, thereby reducing soil erosion and air particulate matter (in case of light substrates e.g. fly ash) and more functionally enhances the firmness of the fly ash particles in the ash pond. This has a direct relevance to the incidence at the site of industries, where the industries gave way after heavy rains, and the flowing substrate contaminates the agricultural land in several surrounding villages. The aforesaid technological interventions can totally prevent such incidents. It was also observed during such intervention that using waste converted compost and such microorganisms accelerate weathering indicating possible conversion of ash into a growing medium in shorter duration.

The hyphae and mycelium of mycorrhizae can spread to areas beyond the rhizosphere of the plant where the plant roots cannot reach and access the nutrient from non-available pool. The infection of a plant with mycorrhizal fungi leads to an increased cell wall surface due to the fungal mycelium inside and outside the root, which is available for metal adsorption.

Hence, in the present scenario the realization amongst the researchers is that through the biomediation of mycorrhizal association it is not only possible to ensure a high degree of soil fertilization but also achieve mineral uptake as well as devise ways and means for reclamation of the industrially created wastelands.

The prior art profile indicates the existence of numerous biofertilizer compositions and biofertilizer formulations obtained from variety of sources, but biofertilizer compositions and biofertilizer formulations capable of serving as biofertilization produced through novel method and equipped to assist in reclamation of industrial wastelands and also serving as effective disease control agent are the novel aspect of this invention, and the same are hitherto unknown.

The U.S. Pat. No. 7,232,565 issued in favor of Henson et al discloses an invention wherein is described an invention that is invention is directed to methods and compositions of endophytic fungi that confer stress tolerance in inoculated plants, including both monocots and dicots. In particular, Curvularia species, isolated from a host grass Dichanthelium languinosum growing in the geothermal zones of Lassen Volcanic and Yellowstone National Parks, confers such stress tolerance. Upon inoculating a target plant or plant part with endophytic fungi, the resulting plant shows stress tolerance, particularly drought and thermal tolerance.

The U.S. Pat. No. 6,871,446 issued in favor of Yamashita discloses an invention pertaining to microbial blend compositions wherein are described microbial blend compositions and method for their use. The subject compositions comprise a plurality of distinct microbial species that all share the following characteristics: (i) are antagonistic against a plurality of microbial pathogens; (ii) are non-pathogenic towards plants and animals; (iii) are tolerant of high temperatures; (iv) grow rapidly; and (v) proliferate on a complex substrate. In many embodiments, the compositions further include a carrier, e.g., a liquid or solid carrier medium. In practicing the subject methods, the compositions are applied to at least one of soil and plant tissue, and in certain embodiments are applied in conjunction with a complex substrate. Also provided are methods of preparing the subject compositions.

The U.S. Pat. No. 4,551,165 issued in favor of Warner discloses an invention pertaining to seed pellets of mycorrhizal origin. This patent goes on to describe that it has been a problem to pellet seeds with inoculum of the beneficial VA mycorrhizal fungus. Hitherto, clay or soil pellets have been tried but they are difficult to adjust to a suitable moisture content and the pellets are too heavy, and there is a problem in placement of the seed so as to ensure that the radicle will grow through the pellet and thereby pick up the desired fungal infection. It has now been found that satisfactory pellets can be made using a mixture of peat, preferably sphagnum moss peat (instead of soil), together with a binder, seed and the VA mycorrhizal fungus, and that even when the pellet is dried considerably the inoculum retains infectivity for at least 6 months, using sphagnum moss peat. The composition in compacted, sowing unit, e.g. pellet, form and a method of growing plant from seed are claimed. The invention is useful for improving the condition of poor soil, e.g. filled-in gravel pits or coal mine spoil tips.

The U.S. Pat. No. 4,294,037 issued in favor of Mosse et al discloses an invention related to the production of mycorrhizal fungi wherein is described a process for the production of vesicular-arbuscular (VA) mycorrhizal fungi comprises growing a VA mycorrhizal fungus on plant roots in nutrient film culture. The resulting mycorrhizal fungus infected plant roots are of value in producing a mycorrhizal inoculum, especially for incorporation into a plant growth medium to enhance the uptake of nutrient by plants grown therein. According to this patent this invention is invention is widely applicable among mycorrhizal systems. Among the very wide variety of plants susceptible to mycorrhizal infection, including Gymnosperms and particularly Angiosperms, preferred hosts are those which are capable of forming large quantities of mycorrhizal roots with the host plant well adapted to nutrient film culture. One particular class of plants of great interest is the legumes in view of their ability to fix atmospheric nitrogen in their nodules (inhabited by bacteria) which obviates the necessity for the addition of nitrogen in the culture solution and thereby avoids the possible inhibition of mycorrhizal development by excess inorganic nitrogen. Examples of legumes are clover, lucerne and particularly beans. In some instances, however, the presence of the legume bacteria in the inoculum may be a disadvantage and a non-legume may be preferred. Such non-legumes include cereals and particularly maize. A possible additional advantage is provided by the use of a host plant which will also produce crop for harvesting and in this respect vegetables for human consumption are of particular interest, for example beans and capsicums, but also particularly those crops which are currently grown commercially in nutrient film culture, for example cucumbers and particularly tomatoes and lettuces. An alternative possibility is plants which produce flowers such as carnations, chrysanthemums and freesias.

The U.S. Pat. No. 5,554,530 issued in favor of Fortin et al discloses an invention wherein is described a method of producing mycorrhizal fungal propagules in vitro in a two-compartment container having a gellified medium, which comprises the steps of: a) cultivating aseptically transformed dicotyledon root organs, capable of autonomous growth in vitro, in a first compartment containing a mineral minimal medium with sugar, wherein the medium is suitable for root growth; b) inoculating the transformed root organs with endomycorrhizal spores; and c) cultivating the inoculated transformed root organs for a time sufficient for the mycorrhizal fungi to transfer to a second root-free and root exudate-free compartment containing the mineral minimal medium of step a) and for the mass production of fungal propagules to occur in the second compartment.

The U.S. Pat. No. 5,096,481 issued in favor of Sylvia et al discloses an invention wherein is described a vesicular-arbuscular mycorrhizal inoculum composition comprising host plant roots colonized by at least one species of vesicular-arbuscular mycorrhizal fungus, the colonized roots having a particle size in the range of from about 33 .mu.m to about 425 .mu.m and a propagule density of up to about 1,000,000 vesicular-arbuscular mycorrhizal fungi propagules per gram dry mass of host plant root; methods for the encapsulation thereof and methods for enhancing plant growth utilizing the inocula.

The U.S. Pat. No. 5,912,398 issued in favor of Goldstein et al discrives an invention wherein is disclosed a composition for providing phosphate fertilizer to the root zone of plants. The composition comprises a microorganism capable of producing and secreting a solubilization agent, a carbon source for providing raw material for the microorganism to convert into the solubilization agent, and rock phosphate ore for providing a source of insoluble phosphate that is solubilized by the solubilization agent and released as soluble phosphate. The composition is provided in a physical form, such as a granule, that retains the microorganism, carbon source, and rock phosphate ore, but permits water and soluble phosphate to diffuse into the soil. A method of using the composition for providing phosphate fertilizer to plants is also disclosed.

The U.S. Pat. No. 5,256,544 issued to Rogers et al. describes an industrial scale continuous bioprocess for solubilizing rock phosphate ore by microbial action. The method involves forming an aqueous mixture of phosphate solubilizing microorganisms and phosphate ore particles of an appropriate size and maintaining the mixture under conditions whereby the phosphate ore particles are solubilized by a solubilizing agent produced and released by the microorganisms. The mixture is then fractionated into an aqueous fraction containing the soluble phosphate and a slurry fraction containing undissolved solids. The soluble phosphate is removed from the aqueous fraction, and the microorganisms present in the aqueous fraction are then recycled together with the undissolved solids of the slurry fraction to continue the solubilization and separation process.

The U.S. Pat. No. 4,945,059 issued in favor of Oki et al discloses an invention wherein is described a method of proliferating vesicular arbuscular mycorrhizal fungi (i.e., VAM fungi) is disclosed which comprises inoculating VAM fungi in a soil medium containing a potato and a porous amphoteric ion exchanger, an accelerator and, optionally, in the presence of a VAM formation accelerator. An advantage gained by the use of VAM fungi in cultivation of plants can be found in the fact that smaller amounts of fertilizers need be used when combined with VAM fungi, as opposed to the use of fertilizers alone.

There remains an emerging need for an effective biofertilizer product and developing effective biofertilization methods, which are more compatible with the need for affordable and effective application without much of bias in favor of usage of chemicals and/or chemically derived substances.

In view of the foregoing disadvantages inherent in the above-mentioned prior art, the general purpose of the present invention is:

to provide an improved combination of convenience and utility,

to include all the advantages of the prior art,

to attempt to overcome the major disadvantages/drawbacks of the prior art, and

to provide novel mycorrhizae-based biofertilizer compositions and biofertilizer formulations capable of serving as effective soil fertilization agents and growth promoters as well as enhancers.

### SUMMARY OF INVENTION

The present invention provides new mycorrhizae-based biofertilizer compositions and biofertilizer formulations capable of serving as effective soil fertilization agents and growth promoters as well as enhancers.

The present invention describes the isolation, incubation, production, harvesting and blending of the mycorrhizal cultures to generate diverse broad spectrum mycorrhizae-based biofertilizer compositions and/or formulations for use and exploitation in numerous fields.

The mycorrhizae-based biofertilizer compositions and/or formulations in accordance with the technology contained in the present invention are is a multipurpose and multi-faceted product-it is a soil conditioner, bio-remediator, and bio-control agent and has wide applications in agriculture, plantations, horticulture, forestry, and biofuels. It offer sustainable and environment-friendly solutions to almost all cultivated plants and crops by enhancing nutrition and yields up to 5%-25%, and curtailing chemical fertilizer inputs by 50%. It has also shown immense potential in reclamation of stressed ecosystems like fly ash dumps, sites loaded with alkali chlor sludge or distillery effluents, and other man-made wastelands.

For a better understanding of the invention, its operating advantages and the specific objects attained by its user, reference should be made to the accompanying drawings and descriptive matter in which there are illustrated embodiments of the invention.

### BRIEF DESCRIPTION OF DRAWINGS

For a better understanding of the nature of the present invention, reference should be made to the detailed description taken in conjunction with the accompanying drawings in which:

FIG. 1 is a diagrammatic depiction of the simplified flow chart for production of mycorrhizae-based biofertilizer compositions.

FIG. 2 is a diagrammatic depiction of plant growth rates on application of mycorrhizae-based biofertilizer compositions of the present invention.

FIG. 3 is a block depiction of industrial wasteland reclamation in accordance with the present invention.

FIG. 4 is a block depiction of an enhancement in plant survival ability in accordance with the present invention.

### DETAILED DESCRIPTION OF INVENTION

The exemplary embodiments described herein detail for illustrative purposes are subject to numerous variations. It is understood that various omissions, substitutions or equivalents are contemplated as circumstances may suggest or render expedient, but is intended to cover the application or implementation without departing from the spirit or scope of the invention.

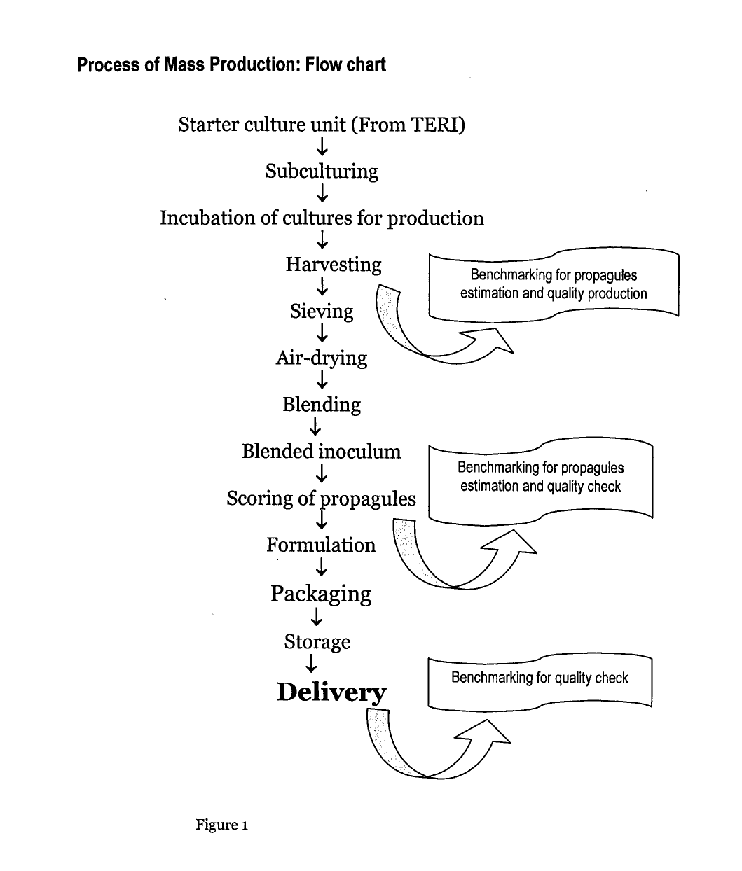

FIG. 1 is a diagrammatic depiction of the simplified flow chart for production of mycorrhizae-based biofertilizer compositions.

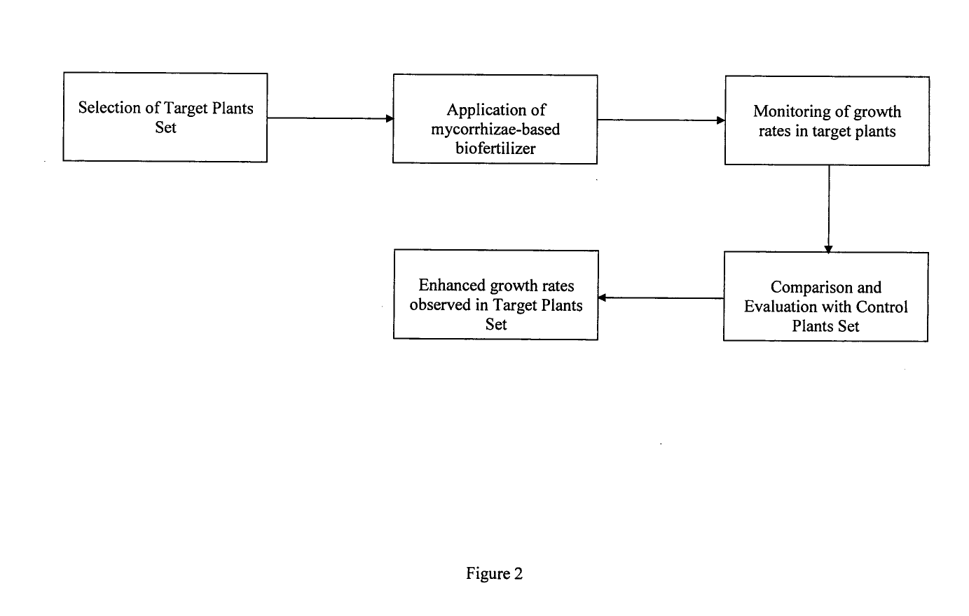

FIG. 2 is a diagrammatic depiction of plant growth rates on application of mycorrhizae-based biofertilizer compositions of the present invention.

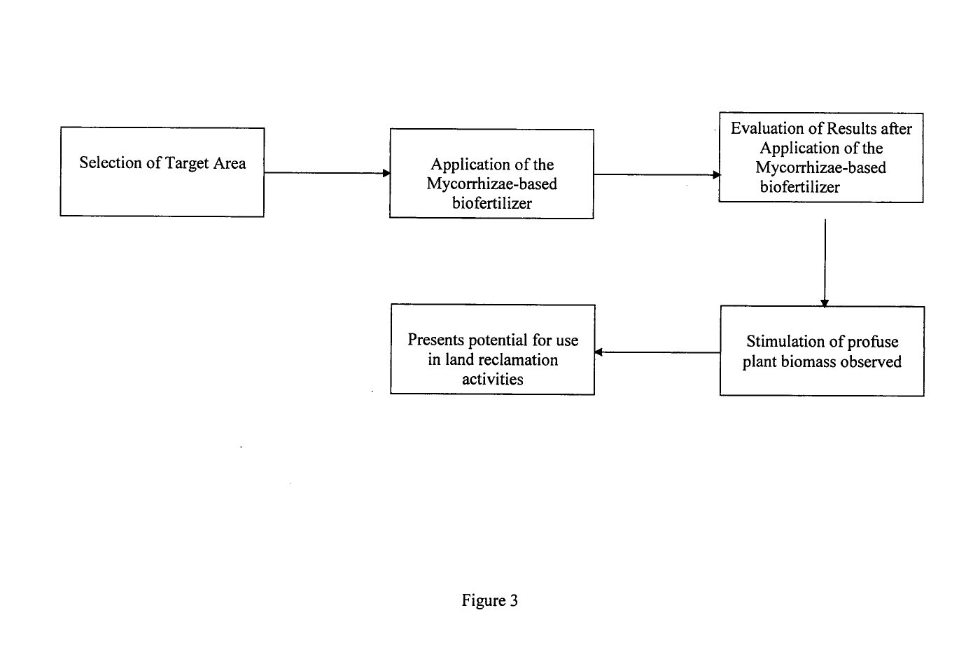

FIG. 3 is a block depiction of industrial wasteland reclamation in accordance with the present invention.

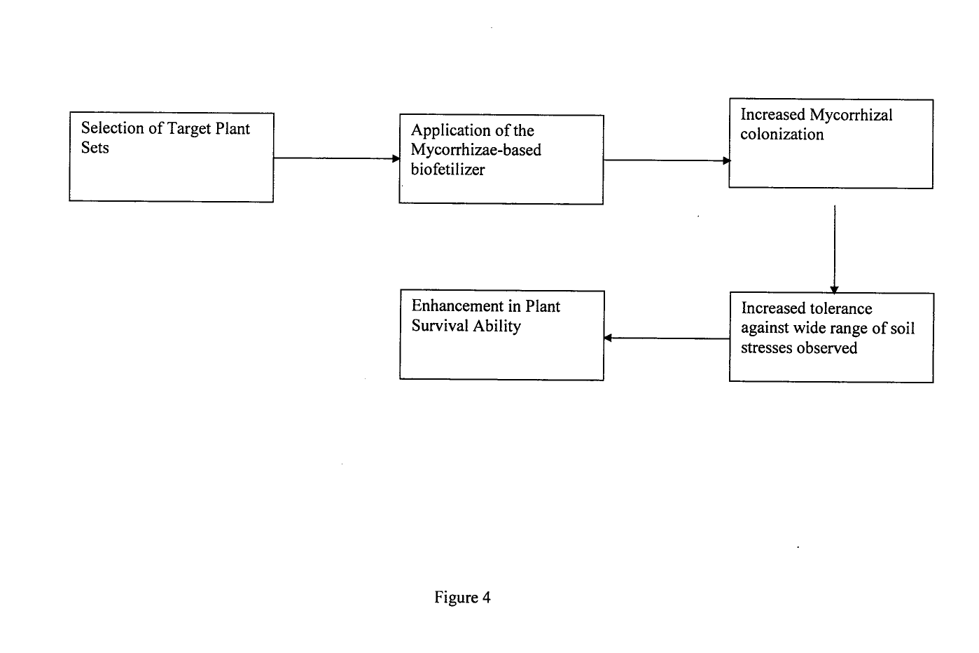

FIG. 4 is a block depiction of an enhancement in plant survival ability in accordance with the present invention.

The process protocol/methodology for obtaining the novel mycorrhizae-based biofertilizer composition/biofertilizer formulation/biofertilizer inoculum composition of the present invention entails the following chronological steps: Isolation exercise for the purpose of generating a starter culture unit, subculturing followed by multiplication, Incubating for mass production, harvesting, sieving, airdrying, Blending to generate a blended inoculums, scoring of propagules, formulation, packaging, and pre-delivery storage.

The preferred embodiment of working of the present invention contemplates, taking a culture inoculum from the already pre-maintained starter culture unit and subjecting the same to subculturing by means of standardized protocols. This is followed by incubation of cultures for production and when the desired growth has been achieved, the harvesting is done. The harvested cultures are then subjected to sieving and air drying. Subsequent to air drying the said harvested cultures are blended with different types of ingredients to generate numerous combinations of blended inoculum. From the blended inoculum the scoring of propagules is carried out to generate several types of the mycorrhizae-based biofertilzer formulations, which are then suitably packaged and stored till the time of delivery.

In accordance with one of the preferred embodiments of the present invention, the culture inoculum is taken from a culture group that contains at least one of fungus from the Glomus, Gigaspora and Scutellospora genera, in the form of a pre-maintained starter culture. These are then subjected to subculturing followed by incubation for attaining the desired growth. At the designated point when the desired growth has been achieved, the procedure for harvesting is put into effect. The harvested cultures are then subjected to sieving and air drying followed by blending to generate the various conceivable combinations for blended inoculum.

In one of the preferred embodiments of working of the present invention, it is contemplated that by effecting colonization of plant roots by the inoculum composition of the present invention, an enhanced plant growth rate can be achieved on account of the inoculum composition's ability to stimulate better uptake of nutrients like phosphorus and immobile trace elements, thereby ensuring that an aim of making better nutrition available to plants is fully met with

In one of the preferred embodiments of the present invention, it is contemplated to obtain the novel mycorrhizae-based biofertilizer composition/biofertilizer formulation which comprise of the isolates obtained from culture group consisting of Glomus clarum and a consortium of selected Glomus species. The embodiment further proceeds by taking a culture inoculum from the already pre-maintained starter culture unit and subjecting the same to subculturing by means of standardized protocols. This is followed by incubation of cultures for production and when the desired growth has been achieved, the harvesting is done. The harvested cultures are then subjected to sieving and air drying. Subsequent to air drying the said harvested cultures are blended with different types of ingredients to generate numerous combinations of blended inoculum. From the blended inoculum the scoring of propagules is carried out to generate several types of the mycorrhizae-based biofertilzer formulations, which are then suitably packaged and stored till the time of delivery.

In another preferred embodiment of the present invention, it is contemplated that by increasing mycorrhizal colonization on plant roots by the inoculum composition of the present invention, an increased tolerance against a wide range of soil stresses such as the heavy metal toxicity, salinity, drought, and high soil temperatures can be developed in the plants, thereby ensuring that in the presence of the inoculum composition of the present invention, chances of plant survival are greatly enhanced.

In yet another preferred embodiment of the present invention, it is contemplated that on account of the ability of the inoculum composition of the present invention to stimulate the development of profuse plant biomass and functionally enhancing the firmness of flyash particles, the present invention could also be effectively put to use in land reclamation activities.

Although, a particular exemplary embodiment of the invention has been disclosed in detail for illustrative purposes, it will be recognized to those skilled in the art that numerous variations or modifications of the disclosed invention, including the rearrangement in the molecular configuration of the mycorrhizae-based biofertilizer compositions and/or formulations of the present invention as well as its method of use being amenable to modifications on account of an application in diverse fields such as soil biofertilization, reclamation of industrially created wastelands, serving as suitable biocontrol agent, effective enhancement of plant productivity, facilitating enhanced nutrient uptake in plants, and exploitation in field of biofuel crops as well as biopesticide formulation based biomarkers are possible.

Accordingly, the invention is intended to embrace all such alterations, modifications and variations as may fall within the spirit and scope of the present invention.

1-30. (canceled)

31. A mycorrhizae-based biofertilizer composition/biofertilizer formulation/biofertilizer inoculum composition isolated from a culture group comprising at least one genus of air dried fungus selected from the group consisting of:
(A). Glomus genus, wherein said Glomus genus comprises species selected from the group consisting of Glomus intraradices, Glomus clarum and Glomus etunicatum;
(B). Gigaspora genus, wherein said Gigaspora genus comprises species selected from the group consisting of Gigaspora decipens, Gigaspora margarita, Gigaspora rosea and Gigaspora albida;
and,
(C). Scutellospora genera, wherein said Scutellospora genus is inclusive of species such as Scutellospora hetrogama, Scutellospora pellucida and Scutellospora fulgida.

32. A mycorrhizae-based biofertilizer composition/biofertilizer formulation isolated from culture group comprising at least one of selected air-dried fungus of uncultured type belonging to genus Glomus, wherein said selected fungus has affinity to Glomus intraradices.

33. A mycorrhizae-based biofertilizer composition/biofertilizer formulation comprising air-dried isolates obtained from a culture group containing Glomus clarum and a consortium of selected Glomus species.

34. The mycorrhizae-based biofertilizer composition/biofertilizer formulation of claim 33, wherein said consortium of selected Glomus species further comprises:
(a). Glomus species with affinity to Glomus intraradices;
and,
(b). Glomus species with affinity to Glomus etunicatum.

35. The mycorrhizae-based biofertilizer composition/biofertilizer formulation of claim 31, wherein said composition is possessing plant productivity enhancing attributes.

36. The mycorrhizae-based biofertilizer composition/biofertilizer formulation of claim 31, wherein said composition possesses better nutrient uptake facilitating attributes.

37. The mycorrhizae-based biofertilizer composition/biofertilizer formulation of claim 31, wherein said composition is possessing land reclamation facilitating attributes, for reclamation of industrially created wastelands.

38. A method for producing a mycorrhizae-based biofertilizer composition/biofertilizer formulation/biofertilizer inoculum composition from plant parts belonging to a group comprising at least one genus of fungus selected from the group consisting of Glomus, Gigaspora and Scutellospora genera, said method comprising steps of:
(a) Isolation to generate a starter culture unit;
(b) Subculturing followed by Multiplication;
(c) Incubating for mass production;
(d) Harvesting, wherein subsequent to said harvesting in Step (d), benchmarking for propagules estimation and quality production is carried out;
(e). Sieving;
(f). Air drying;
(g). Blending to generate a blended inoculum;
(h). Scoring of propagules, wherein subsequent to said scoring of propagules in Step (h), benchmarking for propagules estimation and quality check is carried out;
(i). Formulation;
(j). Packaging;
and,
(k). Pre-delivery Storage, wherein at the time of said pre-delivery storage in Step (k), benchmarking for quality check is carried out.

39. The method according to claim 38, wherein said selected fungus further comprises at least one of Glomus intraradices, Glomus clarum and Glomus etunicatum whether used in isolation or in combination with each other or in combination with any other Glomus species having affinity to Glomus intraradices.

40. A method of enhancing plant growth by increasing mycorrhizal colonization on plant roots comprising effecting the growth of plants in the presence of an amount of an inoculum composition of claim 31 sufficient to stimulate better uptake of nutrients optionally comprising phosphorus and immobile trace elements, wherein said immobile trace elements are selected from the group consisting of zinc, cobalt, copper, magnesium iron and molybdenum, with said stimulated better uptake being responsible for making better nutrition available to plants.

41. A method of enhancing plant growth by increasing mycorrhizal colonization on plant roots comprising effecting the growth of plants in the presence of an amount of an inoculum composition of claim 32 sufficient to stimulate better uptake of nutrients comprising phosphorus and immobile trace elements, wherein said immobile trace elements are selected from the group consisting of zinc, cobalt, copper, magnesium iron and molybdenum, with said stimulated better uptake being responsible for making better nutrition available to plants.

42. A method of enhancing plant survival by increasing mycorrhizal colonization on plant roots comprising effecting an increased tolerance against a wide range of soil stresses in the presence of an amount of an inoculum composition of claim 31 sufficient to stimulate better survival.

43. A method of enhancing plant survival by increasing mycorrhizal colonization on plant roots comprising effecting an increased tolerance against a wide range of soil stresses in the presence of an amount of an inoculum composition of claim 32 sufficient to stimulate better survival.

44. A method of enhancing plant survival by increasing mycorrhizal colonization on plant roots comprising effecting an increased tolerance against a wide range of soil stresses in the presence of an amount of an inoculum composition of claim 33 sufficient to stimulate better survival.

45. A method of enhancing plant growth by increasing mycorrhizal colonization on plant roots comprising effecting the growth of plants in the presence of an amount of an inoculum composition of claim 3 sufficient to stimulate better uptake of nutrients wherein said nutrients optionally comprise phosphorus and immobile trace elements, with an aim to making better nutrition available to plants.
